(19) United States
(12) Patent Application Publication
(10) Pub. No.: US 2024/0192340 A1
(43) Pub. Date: Jun. 13, 2024

(54) SENSOR CALIBRATION METHOD AND SENSOR

(71) Applicant: Continental Autonomous Mobility US, LLC, Auburn Hills, MI (US)

(72) Inventors: Wolfgang Schulz, Santa Barbara, CA (US); Barton M. Goldstein, Santa Barbara, CA (US); Nan Luo, San Dimas, CA (US)

(73) Assignee: Continental Autonomous Mobility US, LLC, Auburn Hills, MI (US)

(21) Appl. No.: 18/077,785

(22) Filed: Dec. 8, 2022

(51) Int. Cl. G01S 7/497

(52) U.S. Cl. CPC G01S 7/497; G01D 18/00

(57) ABSTRACT

According to various embodiments, a sensor calibration method may be provided. The sensor calibration method may include determining a general temperature dependence of correction values of a plurality of sample sensors. The sensor calibration method may further include determining, for a sensor, an amplitude dependence of correction values of the sensor at a predefined temperature. The sensor calibration method may further include correcting output of the sensor based on the amplitude dependence of the correction values of the sensor at the predefined temperature, and further based on the general temperature dependence of the correction values of the plurality of sample sensors.

### TECHNICAL FIELD

Various embodiments relate to sensor calibration methods and sensors, in particular, LiDAR sensors.

### BACKGROUND

Light detection and ranging (LiDAR) is emerging as an important technology for semi or fully autonomous driving applications. Automotive LiDAR systems may use pulsed laser light to measure distances between a vehicle and other vehicles or obstacles, and may provide superior accuracy and resolution as compared to radar sensors. LiDAR sensors may also generate three-dimensional (3D) sensing data by measuring distance between the LiDAR sensor and everything in its field of view. The resulting 3D sensing output may be used for a range of driving functions including collision warning and avoidance systems, lane-keep assistance, lane-departure warning, blind-spot monitors, and adaptive cruise control.

In order for LiDAR sensors to generate accurate outputs, their sensing outputs need to be calibrated. The ranging measurement i.e. measured distance, of LiDAR sensors generally has an error that varies with both the amplitude of the laser pulse and the temperature of the LiDAR electronic components. However, it is challenging to measure the error dependency on temperature and amplitude for each LiDAR sensor that is manufactured, as the LiDAR sensor requires a long time to achieve thermal equilibrium. An existing calibration method includes applying a generic set of calibration coefficients to correct for the temperature-induced error, but the accuracy of this method is low. Another calibration method is to perform a full over run over automotive temperature range for each LiDAR sensor, but this method is time consuming.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to various embodiments, a sensor calibration method may be provided. The sensor calibration method may include determining a general temperature dependence of correction values of a plurality of sample sensors. The sensor calibration method may further include determining, for a sensor, an amplitude dependence of correction values of the sensor at a predefined temperature. The sensor calibration method may further include correcting output of the sensor based on the amplitude dependence of the correction values of the sensor at the predefined temperature, and further based on the general temperature dependence of the correction values of the plurality of sample sensors.

According to various embodiments, a sensor may be provided. The sensor may include a non-volatile memory and a processor. The non-volatile memory may store first data and second data. The first data may be representative of a general temperature dependence of correction values of a plurality of sample sensors, and the second data may be representative of amplitude dependence of correction values of the sensor at a predefined temperature. The processor may be configured to correct an output of the sensor based on the first data and further based on the second data.

According to various embodiments, a data structure may be provided. The data structure may be generated by a sensor, such as the sensor described above. The data structure may include outputs of the sensor corrected based on first data and second data stored in a non-volatile memory of the sensor. The first data may be representative of a general temperature dependence of correction values of a plurality of sample sensors, and the second data may be representative of amplitude dependence of correction values of the sensor at a predefined temperature.

Other objects, features and characteristics, as well as the methods and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the non-limiting embodiments of the disclosure, are intended for purposes of illustration only and are not intended to limit the scope of the disclosure.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed subject matter. The present disclosure will become more fully understood from the detailed description and the accompanying drawings, wherein:

FIG. 1 shows a graph with six curves, each curve representing the relationship between range correction values and pulse amplitude of a sensor at a respective temperature.

FIG. 2 shows an example of the amplitude dependence of correction values of a sensor measured at ambient temperature, in a graph.

FIG. 3 shows an example of the general temperature dependence of correction values, in a graph.

FIG. 4 shows a flow diagram of a sensor calibration method according to various embodiments.

FIG. 5 shows a simplified block diagram of a sensor according to various embodiments.

FIG. 6 shows a simplified block diagram of a data structure according to various embodiments.

### DESCRIPTION

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

Embodiments described below in context of the devices are analogously valid for the respective methods, and vice versa. Furthermore, it will be understood that the embodiments described below may be combined, for example, a part of one embodiment may be combined with a part of another embodiment.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

In this context, the device as described in this description may include a memory which is for example used in the processing carried out in the device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In order that the invention may be readily understood and put into practical effect, various embodiments will now be described by way of examples and not limitations, and with reference to the figures.

According to various embodiments, a sensor calibration method 400 is provided. The sensor calibration method 400 may be used to calibrate a sensor 500. The sensing outputs of the sensor 500 may be used to support autonomous driving, or advanced driver assistance applications.

According to various embodiments, the sensor 500 may be a LiDAR sensor. For example, the LiDAR sensor may be a scanning and starting time-of-flight LiDAR. For example, the sensor 500 may be a 3D imaging sensor.

The sensor 500 may be configured to measure distances to objects in its field of view (FOV). The sensor 500 may measure the distances to an accuracy of a few centimeters while the received light energies span five orders of magnitude. The sensor 500 may monitor several dozen frames per second in a wide FOV. To fulfil these requirements, the sensor 500 may incorporate non-linear electronic and optical components that introduce systematic range-to-target errors that need to be compensated by calibrating the measurements of the sensor 500 by correction values. The range correction values required to compensate for the error in range may depend on pulse amplitude, also referred herein simply as “amplitude”, of the sensor 500, as well as the temperature of the sensor 500.

According to various embodiments, the sensor calibration method 400 may provide an efficient means to correct the time walk of automotive-grade LiDAR sensors. The sensor calibration method 400 may correct the time walk with decomposed polynomial coefficients.

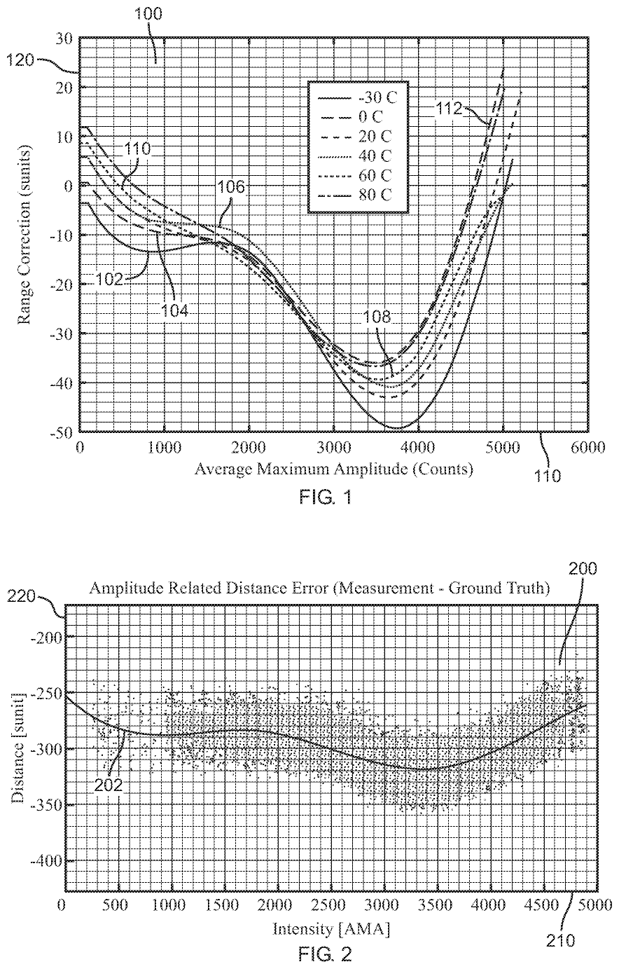

FIG. 1 shows a graph 100 with six curves, each curve representing the relationship between range correction values and pulse amplitude of the sensor 500 at a respective temperature. In other words, each curve shows the range correction values as a function of pulse amplitude at a respective temperature. The relationship between range correction values and pulse amplitude of the sensor is also referred herein as amplitude dependence of correction values. The amplitude dependence of correction values may be represented by a mathematical function, where the correction value is expressed as a function of amplitude. The horizontal axis 110 of the graph 100 represents average maximum amplitude measured in counts, while the vertical axis 120 of the graph 100 represents range correction measured in sunits, where each sunit is 1/256 meters. The curve 102 shows the amplitude dependence of correction values at −30° ° C., the curve 104 shows the amplitude dependence of correction values at 0° C., the curve 106 shows the amplitude dependence of correction values at 20° C., the curve 108 shows the amplitude dependence of correction values at 40° C., the curve 110 shows the amplitude dependence of correction values at 60° C., and the curve 112 shows the amplitude dependence of correction values at 80° C. The six curves have similar shapes, indicating that the range correction depends more strongly on amplitude than on temperature. In other words, the range correction's dependence on temperature is weak while its dependence on amplitude is strong. The sensor calibration method 400 may make use of this characteristic, i.e. the stronger dependence on amplitude than on temperature, of the range correction values. The sensor calibration method 400 may include measuring the amplitude dependence of the correction values for a sensor 500 at a predefined temperature, for example, room temperature. This may be done rapidly because temperature equilibrium is already established. To compensate for the effects of temperature, the sensor 500 may be calibrated using the temperature dependence of the average sensor, rather than based on testing the sensor 500 at various different temperatures. The resulting range error may be small as the temperature only weakly affects the range correction values. The temperature dependence of the correction values refers to the relationship between range correction values and the temperature of the sensor 500. The temperature dependence of the correction values may be represented by a mathematical function, where the correction value is expressed as a function of temperature.

According to various embodiments, the sensor calibration method 100 may include correcting the time walk, also referred to as range walk, of the sensor 500 with decomposed polynomial coefficients. The sensor calibration method 100 may include applying individual time walk correction to a sensor 500 in a time efficient manner by using pre-stored delta temperature coefficients. The sensor calibration method 100 may include decomposing the necessary correction coefficients into (a) temperature delta coefficients, and (b) sensor-specific at ambient temperature coefficients. The temperature delta coefficients may represent a general temperature dependence of the correction values of an “average sensor”. The general temperature dependence of the correction values of the “average sensor” may be determined by measuring the temperature dependence of correction values of a plurality of sensors 200, and then applying a mathematical function to the measurements. The mathematical function may be an averaging function. In other embodiments, other mathematical functions that may extract a general representation may also be applied. The sensor-specific at ambient temperature coefficients may represent the amplitude dependence of correction values of the sensor 500 that is to be calibrated, at a predefined temperature. The sensor calibration method 100 may further include storing both of the coefficient sets into a non-volatile sensor configuration. The non-volatile sensor configuration may be saved as part of the production parameter (PPAR) of the sensor 500. To calibrate the sensor 500, the temperature delta coefficients and the sensor-specific coefficients may be applied sequentially to the measurements of the sensor 500.

FIG. 2 shows an example of the amplitude dependence of correction values of a sensor 500 measured at ambient temperature, in a graph 200. The graph 200 includes a horizontal axis 210 that represents intensity measured in AMA, and a vertical axis 220 that represents distance error measured in sunits. The dots in the graph 200 are measurement data points of amplitude-related distance error, i.e. ground truth measurements, while the curve 202 is a best-fit mathematical function to the data points.

The sensor calibration method 400 may include measuring the distance error, i.e. range error of the sensor 500 that is to be calibrated. The distance error may be determined by using the sensor 500 to measure distance to a test object, and then comparing the measurement generated by the sensor to the ground truth distance to the test object. The distance error may be a difference between the ground truth distance and the measurement. The distance error may be measured across a range of amplitudes as shown in the graph 200. In other words, the determination of distance error may be repeated for different pulse amplitudes emitted by the sensor 500. Next, the data points collected may be recorded, and may be fitted to a mathematical function such as a polynomial or a plurality of splines. The coefficients to the mathematical function 202 may be computed, and these coefficients may be stored in the sensor 500 as second data.

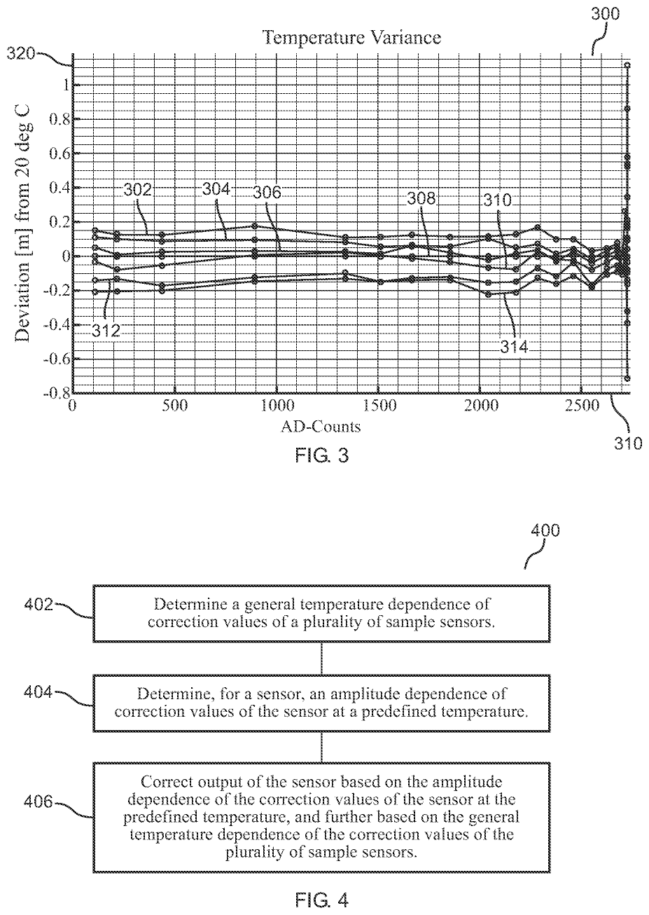

FIG. 3 shows an example of the general temperature dependence of correction values, in a graph 300. The graph 300 includes a horizontal axis 310 that represents analog-digital conversion (AD) measured in counts, and a vertical axis 320 that represents deviation from the distance error measured at 20° C. The graph 300 includes 7 plots, each of which represents the deviation from the distance error measured at 20° C., at a respective temperature. The plot 302 shows the deviation at −30° C., the plot 304 shows the deviation at −10° C., the plot 304 shows the deviation at −10° C., the plot 306 shows the deviation at 10° C., the plot 308 shows the deviation at 20° C., the plot 310 shows the deviation at 30° C., the plot 312 shows the deviation at 70° C., and the plot 314 shows the deviation at 80° ° C. The seven plots have similar shapes, indicating that the temperature difference has a relatively weak effect on the distance error, also referred herein as “range error”. To calibrate the sensor 500, the distance error obtained from FIG. 2 may be adjusted according to the temperature of the sensor 500, and the plots in the graph 300. For example, at a temperature of 80° C., the correction value for calibrating the sensor may be a sum of the distance error from FIG. 2 and the deviation from the plot 314. The data points from the plots in FIG. 3 may also be fitted to a second mathematical function such as a polynomial or a plurality of splines. The coefficients to the second mathematical function may be computed, and these coefficients may be stored in the sensor 500 as first data.

FIG. 4 shows a flow diagram of a sensor calibration method 400 according to various embodiments. The sensor calibration method 400 may include determining a general temperature dependence of correction values of a plurality of sample sensors, in 402. The general temperature dependence of correction values may include, for example, the data shown in FIG. 3. The sensor calibration method 400 may further include determining, for a sensor 500, an amplitude dependence of correction values of the sensor 500 at a predefined temperature. The amplitude dependence of correction values may include, for example, the data shown in FIG. 2. The sensor calibration method 400 may further include correcting output of the sensor 500 based on the amplitude dependence of the correction values of the sensor 20 at the predefined temperature, and further based on the general temperature dependence of the correction values of the plurality of sample sensors. The sensor calibration method 400 may require just one generic oven run of the plurality of sample sensors, to generate the data points for the general temperature dependence of the correction values. After determining the general temperature dependence of the correction values, each sensor 500 to be calibrated only needs to be run, i.e. operated and/or tested, at ambient temperature, to generate the sensor-specific amplitude dependence of correction values. The sensors 200 to be calibrated need not be put through full oven runs to obtain accurate correction values for time walk compensation. Consequently, the sensor calibration method 400 shortens the time required to calibrate the sensors 200.

According to an embodiment which may be combined with any above-described embodiment or with any below described further embodiment, correcting the output of the sensor 500 may include correcting the output based on the amplitude dependence of the correction values of the sensor 500 at the predefined temperature to result in an intermediate output. Next, the intermediate output may be corrected based on the general temperature dependence of the correction values of the plurality of sample sensors. In essence, the necessary correction values were decomposed to two components—the amplitude dependence for the specific sensor 500, and the general temperature dependence characteristic obtained by testing multiple sensors. The latter is pre-generated and the amplitude dependence for the specific sensor 500 may then be adjusted to account for temperature effects based on the pre-generated general temperature dependence.

According to an embodiment which may be combined with any above-described embodiment or with any below described further embodiment, determining the general temperature dependence of correction values of the plurality of sample sensors may include determining for each sample sensor of the plurality of sample sensors, a respective temperature dependence of the correction values of the sample sensor, and determining an average of the temperature dependence of the correction values of the plurality of sample sensors, to result in a temperature correction curve. The average value of the temperature dependence of multiple sample sensors may provide a representation of the general temperature dependence characteristic of the sensor 500.

According to an embodiment which may be combined with any above-described embodiment or with any below described further embodiment, determining for each sample sensor of the plurality of sample sensors, a respective temperature dependence of the correction values of the sample sensor, may include measuring respective amplitude dependence of the correction values of the sample sensor, at a plurality of temperatures. These amplitude dependence data may then be compared to the amplitude dependence data obtained for the sensor 500 at a predefined temperature, to determine a difference in distance error for adjusting the required correction values.

According to an embodiment which may be combined with any above-described embodiment or with any below described further embodiment, determining the general temperature dependence of correction values of the plurality of sample sensors may include fitting the temperature correction curve with a polynomial, and determining coefficients of the polynomial. Determining a best-fit polynomial may allow the correction values, or the deviation in correction values from a predefined temperature, to be expressed as a function of temperature. The polynomial may be used to extrapolate or determine values that do not exactly match the collected data points. Also, storing the polynomial and the coefficients may require less memory capacity, as compared to storing all the data points.

According to an embodiment which may be combined with any above-described embodiment or with any below described further embodiment, the sensor calibration method 400 may further include storing in the sensor 500, first data and second data, wherein the first data is representative of the general temperature dependence of correction values of the plurality of sample sensors, and the second data is representative of amplitude dependence of correction values of the sensor at the predefined temperature. The sensor 500 may then self-correct its measurements based on the stored first data and second data.

According to an embodiment which may be combined with any above-described embodiment or with any below described further embodiment, at least one of the first data and the second data may include a set of coefficients for at least one mathematical function.

According to an embodiment which may be combined with any above-described embodiment or with any below described further embodiment, the general temperature dependence of correction values of the plurality of sample sensors, and the amplitude dependence of correction values of the sensor at the predefined temperature, are stored in a non-volatile memory of the sensor.

According to an embodiment which may be combined with any above-described embodiment or with any below described further embodiment, determining the amplitude dependence of correction values of the sensor at a predefined temperature may include measuring respective correction values of the sensor at a plurality of different amplitudes, to generate an amplitude correction curve, and fitting the amplitude correction curve with at least one mathematical function, and determining coefficients of the mathematical function.

According to an embodiment which may be combined with any above-described embodiment or with any below described further embodiment, the at least one mathematical function may include a polynomial.

According to an embodiment which may be combined with any above-described embodiment or with any below described further embodiment, the at least one mathematical function may include a plurality of splines. A plurality of splines may fit the data more closely than a polynomial.

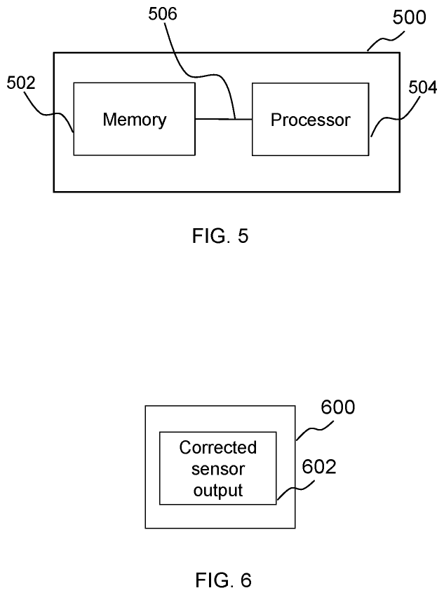

FIG. 5 shows a simplified block diagram of a sensor 500 according to various embodiments. The sensor 500 may include a memory 502. The memory 502 may be a non-volatile memory such as read-only memory and non-volatile read-access memory. The memory 502 may store first data that is representative of a general temperature dependence of correction values of a plurality of sample sensors. The memory 502 may also store second data that is representative of amplitude dependence of correction values of the sensor at a predefined temperature. The sensor 500 may further include a processor 504. The processor 504 may be configured to correct an output of the sensor based on the first data and further based on the second data. The memory 502 and the processor 504 may be coupled to each other via a connection 506. Various aspects described with respect to the sensor calibration method 400 may also be applicable to the sensor 500.

According to an embodiment which may be combined with any above-described embodiment or with any below described further embodiment, the sensor 500 may be a LiDAR sensor.

According to an embodiment which may be combined with any above-described embodiment or with any below described further embodiment, the processor 504 may be configured to correct the output of the sensor 500 by correcting the output based on the second data to obtain an intermediate output, followed by correcting the intermediate output based on the first data.

FIG. 6 shows a simplified block diagram of a data structure 600 according to various embodiments. The data structure 600 may be generated by a sensor, such as the sensor 500. The data structure 600 may include corrected sensor output 602. The corrected sensor output 602 may be corrected, for example by the processor 504, based on first data and second data stored in a non-volatile memory of the sensor 500. The first data may be representative of a general temperature dependence of correction values of a plurality of sample sensors, and the second data may be representative of amplitude dependence of correction values of the sensor at a predefined temperature. The data structure 600 may include measurements of distances of objects within the FOV of the sensor 500, from the sensor 500. The measurements indicated in the data structure 600 may be accurate, in that they have already accounted for range walk of the sensor 500 due to variations in temperature and pulse amplitude of the sensor 500.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The word “exemplary” is used herein to mean “serving as an example, instance, or illustration.” Any aspect described herein as “exemplary” is not necessarily to be construed as preferred or advantageous over other aspects. Reference to an element in the singular is not intended to mean “one and only one” unless specifically so stated, but rather “one or more.” Combinations such as “at least one of A, B, or C”, and “at least one of A, B, and C,” include any combination of A, B, and/or C, and may include multiples of A, multiples of B, or multiples of C. Specifically, combinations such as “at least one of A, B, or C”, and “at least one of A, B, and C,” may be A only, B only, C only, A and B, A and C, B and C, or A and B and C, where any such combinations may contain one or more member or members of A, B, or C.

The foregoing description shall be interpreted as illustrative and not be limited thereto. One of ordinary skill in the art would understand that certain modifications may come within the scope of this disclosure. Although the different non-limiting embodiments are illustrated as having specific components or steps, the embodiments of this disclosure are not limited to those combinations. Some of the components or features from any of the non-limiting embodiments may be used in combination with features or components from any of the other non-limiting embodiments. For these reasons, the appended claims should be studied to determine the true scope and content of this disclosure.

1. A sensor calibration method comprising:
determining a general temperature dependence of correction values of a plurality of sample sensors;
determining, for a sensor, an amplitude dependence of correction values of the sensor at a predefined temperature; and
correcting output of the sensor based on the amplitude dependence of the correction values of the sensor at the predefined temperature, and further based on the general temperature dependence of the correction values of the plurality of sample sensors.

2. The sensor calibration method of claim 1, wherein correcting the output of the sensor comprises correcting the output based on the amplitude dependence of the correction values of the sensor at the predefined temperature to result in an intermediate output, followed by correcting the intermediate output based on the general temperature dependence of the correction values of the plurality of sample sensors.

3. The sensor calibration method of claim 1, wherein determining the general temperature dependence of correction values of the plurality of sample sensors comprises
determining for each sample sensor of the plurality of sample sensors, a respective temperature dependence of the correction values of the sample sensor, and
determining an average of the temperature dependence of the correction values of the plurality of sample sensors, to result in a temperature correction curve.

4. The sensor calibration method of claim [0032], wherein determining for each sample sensor of the plurality of sample sensors, a respective temperature dependence of the correction values of the sample sensor, comprises
measuring respective amplitude dependence of the correction values of the sample sensor, at a plurality of temperatures.

5. The sensor calibration method of claim [0032], wherein determining the general temperature dependence of correction values of the plurality of sample sensors comprises
fitting the temperature correction curve with a polynomial, and determining coefficients of the polynomial.

6. The sensor calibration method of claim 1, further comprising:
storing in the sensor, first data and second data, wherein the first data is representative of the general temperature dependence of correction values of the plurality of sample sensors, and the second data is representative of amplitude dependence of correction values of the sensor at the predefined temperature.

7. The sensor calibration method of claim 6, wherein at least one of the first data and the second data comprises a set of coefficients for at least one mathematical function.

8. The sensor calibration method of claim 6, wherein the general temperature dependence of correction values of the plurality of sample sensors, and the amplitude dependence of correction values of the sensor at the predefined temperature, are stored in a non-volatile memory of the sensor.

9. The sensor calibration method of claim 1, wherein determining the amplitude dependence of correction values of the sensor at a predefined temperature comprises
measuring respective correction values of the sensor at a plurality of different amplitudes, to generate an amplitude correction curve, and
fitting the amplitude correction curve with at least one mathematical function, and determining coefficients of the mathematical function.

10. The sensor calibration method of claim 9, wherein the at least one mathematical function comprises a polynomial.

11. The sensor calibration method of claim 9, wherein the at least one mathematical function comprises a plurality of splines.

12. The sensor calibration method of claim 1, wherein the sensor is a LiDAR sensor.

13. A sensor comprising:
a non-volatile memory storing first data and second data, wherein the first data is representative of a general temperature dependence of correction values of a plurality of sample sensors, and the second data is representative of amplitude dependence of correction values of the sensor at a predefined temperature; and
a processor configured to correct an output of the sensor based on the first data and further based on the second data.

14. The sensor of claim 13, wherein the sensor is a LiDAR sensor.

15. The sensor of claim 13, wherein the processor is configured to correct the output of the sensor by correcting the output based on the second data to obtain an intermediate output, followed by correcting the intermediate output based on the first data.

16. A data structure generated by a sensor, the data structure comprising outputs of the sensor corrected based on first data and second data stored in a non-volatile memory of the sensor, wherein the first data is representative of a general temperature dependence of correction values of a plurality of sample sensors, and the second data is representative of amplitude dependence of correction values of the sensor at a predefined temperature.
